(19) United States
(12) Patent Application Publication
(10) Pub. No.: US 2026/0205703 A1
(43) Pub. Date: Jul. 16, 2026

(54) SIGNAL PROCESSING CIRCUIT, SIGNAL PROCESSING METHOD, AND PROGRAM

(71) Applicant: Sony Interactive Entertainment Inc., Tokyo (JP)

(72) Inventor: HIDEAKI IWAKI, Kanagawa (JP)

(73) Assignee: Sony Interactive Entertainment Inc., Tokyo (JP)

(21) Appl. No.: 19/138,174

(22) PCT Filed: Dec. 23, 2022
(86) PCT No.: PCT/JP2022/047515

§ 371 Date: Jun. 12, 2025

(51) Int. Cl. H04N 23/745; H04N 25/47

(52) U.S. Cl. CPC H04N 23/745; H04N 25/47

(57) ABSTRACT

Provided is a signal processing circuit which processes an event signal generated by an event-based vision sensor (EVS) and indicating the polarity of a luminance change event for each pixel, the signal processing circuit includes a memory for storing a program code, and a processor for executing an operation in accordance with the program code, and the operation includes detecting a time change cycle of a ratio of the polarity indicated by the event signals generated for each predetermined period of time, and filtering the event signals according to the result of detecting the time change cycle.

### TECHNICAL FIELD

The present invention relates to a signal processing circuit, a signal processing method, and a program.

### BACKGROUND ART

A vision sensor based on events (EVS: Event-based Vision Sensor) is known in which a pixel that detects a change in the intensity of incident light generates an event signal. The EVS is also called an EDS (Event Driven Sensor), an event camera, or a DVS (Dynamic Vision Sensor), and includes a sensor array having sensors including light receiving elements. When the sensor detects a change in the intensity of incident light, more specifically, a change in the luminance of the object surface, the EVS generates an event signal that includes a time stamp, sensor identification information, and information on the polarity of the luminance change. Technologies related to such an EVS are described in PTL 1, PTL 2, and PTL 3, for example.

### CITATION LIST

### Patent Literature

[PTL 1] Japanese Translations of PCT for Patent No. 2014-535098
[PTL 2] Japanese Patent Laid-open No. 2018-85725
[PTL 3] Japanese Patent Laid-open No. 2021-129265

### SUMMARY

### Technical Problem

In the case of using an EVS as described above, there are cases where the occurrence of flickers in the surrounding environment can be a problem. For example, in the case where fluorescent lamps or LED (Light-Emitting Diode) lighting controlled by PWM (Pulse Width Modulation) are placed in the surrounding environment of the EVS, flickers of twice the frequency of the alternating current power supply (100 Hz in the case where the power supply frequency is 50 Hz) and its harmonics, that is, blinking of the light source, occurs, and an event signal is generated due to a change in the luminance of the entire surrounding environment. Since the event signal due to the flicker does not reflect the movement of the subject, etc. and becomes noise in many cases, it is desirable to eliminate this effect as much as possible.

Therefore, an object of the present invention is to provide a signal processing circuit, a signal processing method, and a program capable of reducing the effect of flicker in the surrounding environment on an event signal generated by an EVS.

### Technical Solution

According to one aspect of the present invention, a signal processing circuit is provided, which processes event signals that are generated by an event-based vision sensor (EVS) and each indicate a polarity of a luminance change event for each pixel, the signal processing circuit includes a memory for storing a program code and a processor for executing an operation in accordance with the program code, and the operation includes detecting a time change cycle of a ratio of the polarity indicated by the event signals generated for each predetermined period of time, and filtering the event signals according to a result of detecting the time change cycle.

According to another aspect of the present invention, a signal processing method is provided, which is used to process event signals that are generated by an event-based vision sensor (EVS) and each indicate a polarity of a luminance change event for each pixel, and by an operation executed by a processor in accordance with a program code stored in a memory, the method includes detecting a time change cycle of a ratio of the polarity indicated by the event signals generated for each predetermined period of time, and filtering the event signals according to a result of detecting the time change cycle.

According to yet another aspect of the present invention, a program is provided, which is used to process event signals that are generated by an event-based vision sensor (EVS) and each indicate a polarity of a luminance change event for each pixel, and operations executed by a processor in accordance with the program include detecting a time change cycle of a ratio of the polarity indicated by the event signals generated for each predetermined period of time, and filtering the event signals according to a result of detecting the time change cycle.

### BRIEF DESCRIPTION OF DRAWINGS

FIG. 1 is a diagram illustrating a schematic configuration of a system according to an embodiment of the present invention.

FIG. 2 is a diagram illustrating typical time series changes in event polarity in the case where event signals generated by an EVS are affected by flicker.

FIG. 3 depicts diagrams for illustrating an example of a process for detecting a time change cycle in the polarity ratio indicated by event signals.

FIG. 4 is a diagram illustrating a first example of a functional configuration for detecting the time change cycle and filtering.

FIG. 5 is a diagram illustrating a second example of the functional configuration for detecting the time change cycle and filtering.

FIG. 6 is a flowchart illustrating an example of processing in the case of examples of FIGS. 4 and 5.

FIG. 7 Is a diagram illustrating a third example of the functional configuration for detecting the time change cycle and filtering.

FIG. 8 is a diagram illustrating an example of a detection signal generated in the example of FIG. 7.

FIG. 9 is a diagram illustrating another example of the configuration of the system relating to the embodiment of the present invention.

### DESCRIPTION OF EMBODIMENT

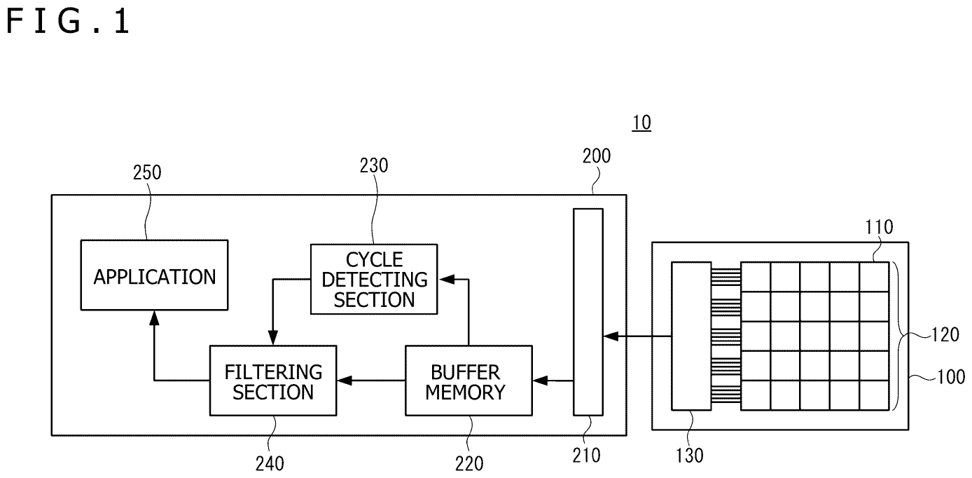

FIG. 1 is a diagram illustrating a schematic configuration of a system according to an embodiment of the present invention. In the illustrated example, a system 10 includes an EVS 100 and a signal processing device 200.

The EVS 100 includes a sensor array 120 containing a plurality of sensors 110, and a sensor control unit 130 connected to the sensor array 120. Each sensor 110 includes a light receiving element and generates an event signal indicating a change in the intensity of incident light, more specifically, a change in luminance. In an image obtained by mapping the event signals on the basis of the addresses of the respective sensors 110 in the sensor array 120, each sensor 110 corresponds to a pixel, and the event signal indicates the polarity of a luminance change event for each pixel. To be specific, the polarity of a luminance change event is positive in the case where the luminance value of each pixel increases beyond a threshold value and is negative in the case where the luminance value decreases to fall below the threshold value. These polarities are expressed as (0) in the case where no event occurs, (1) in the case where a positive event occurs, and (2) in the case where a negative event occurs, as 2-bit information included in the event signal, for example.

In the EVS 100 as described above, for example, an event signal is read from the sensor 110 in accordance with an address generated by an address generating device included in the sensor control unit 130. For example, event signals may be read from all the sensors 110 included in the sensor array 120 in a predetermined order during a predetermined period of time. In this case, while the number of event signals increases, since information identifying the sensor 110 that has generated the event signal is not necessary if the reading order is known, the size of the event signal is reduced by constituting the event signal by using minimum information indicating the presence or absence of the occurrence and the polarity of a luminance change event, such as the above-mentioned 2-bit information. Alternatively, event signals may not be read from the sensors 110 in which no luminance change event has occurred, and event signals may be read time-asynchronously only from the sensors 110 in which a positive or negative luminance change event has occurred. In this case, while the number of event signals decreases, the size of the event signal increases because information identifying the sensor 110 that has generated the event signal is included. Either of the above two readout methods may be adopted in the EVS 100.

The signal processing device 200 includes a communication interface 210, a buffer memory 220, a cycle detecting section 230, a filtering section 240, and an application 250. The communication interface 210 receives an event signal from the sensor control unit 130 of the EVS 100. The received event signal is temporarily stored in the buffer memory 220. The functions of the cycle detecting section 230, the filtering section 240, and the application 250 are implemented by a signal processing circuit in which a processor executes operations in accordance with program codes stored in a memory. Note that the function of the application 250 is not particularly limited to any kind, and may include detection of the movement of a subject, matching of a three-dimensional shape of a subject, or processing of a recognizer using machine learning, for example. Alternatively, the signal processing device 200 does not include the function of an application, and the event signal processed by the filtering section 240 may be output to an external device or stored in a memory.

The cycle detecting section 230 detects a time change cycle of the polarity ratio indicated by the event signals generated for each predetermined period of time by the EVS 100. Here, the predetermined period of time may specifically match the period in which the event signals are read out from all the sensors 110 included in the sensor array 120, or may be a period set on the signal processing device 200 side regardless of the readout process in the EVS 100, for example, in the case where the event signal is read out time-asynchronously. As will be described later, in the case where the event signal generated by the EVS 100 is affected by flicker, a periodic change appears in the polarity ratio indicated by the event signals generated for each predetermined period of time. Therefore, in the present embodiment, the cycle detecting section 230 detects the time change cycle of the polarity ratio indicated by the event signals, and in the case where a detection result that satisfies a predetermined condition is obtained, the event signals for the corresponding time is filtered by the filtering section 240.

The filtering section 240 filters the event signals stored in the buffer memory 220 according to the result of the detection of the time change cycle by the cycle detecting section 230 and transmits the event signals to the application 250. In order to enable such processing, the processing by the cycle detecting section 230 is performed within the range of an allowable delay time in which the event signals are stored in the buffer memory 220. Note that, in another example, the processing by the cycle detecting section 230 and the filtering section 240 may be performed at a later time by reading out the event signal non-temporarily stored in a memory. In this case, the filtering section 240 updates the stored event signals with the filtered event signals. To be specific, in the case where the detection result of the time change cycle indicates that there is an effect of flicker, the filtering section 240 filters out the event signals of either polarity, namely either the positive event signals or the negative event signals. Note that a detailed example of the filtering process based on the detection result of the time change cycle will be described later.

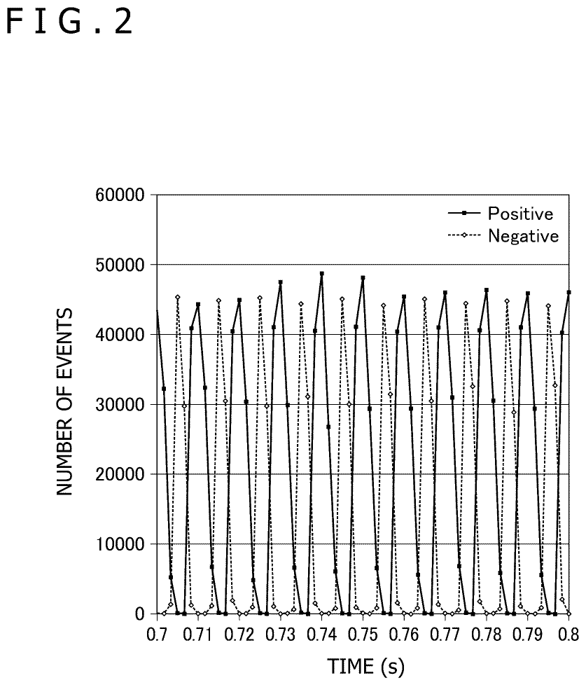

FIG. 2 is a diagram illustrating a typical time series change in event polarity in the case where event signals generated by an EVS are affected by flicker. In the graph of FIG. 2, the horizontal axis indicates time, and the vertical axis indicates the number of positive event signals (Positive) and negative event signals (Negative) generated within a predetermined period of time. In the case where flicker occurs due to fluorescent lights or LED lighting controlled by PWM in the surrounding environment of the EVS, even if the subject is stationary, positive event signals and negative event signals are generated alternately and periodically as illustrated in the example of FIG. 2 due to periodic changes in the luminance of the subject surface. The processing of the cycle detecting section 230 and the filtering section 240 in the signal processing device 200 according to the present embodiment is performed to ignore event signals generated due to the influence of flicker as much as possible and extract event signals generated due to the movement or the like of the subject.

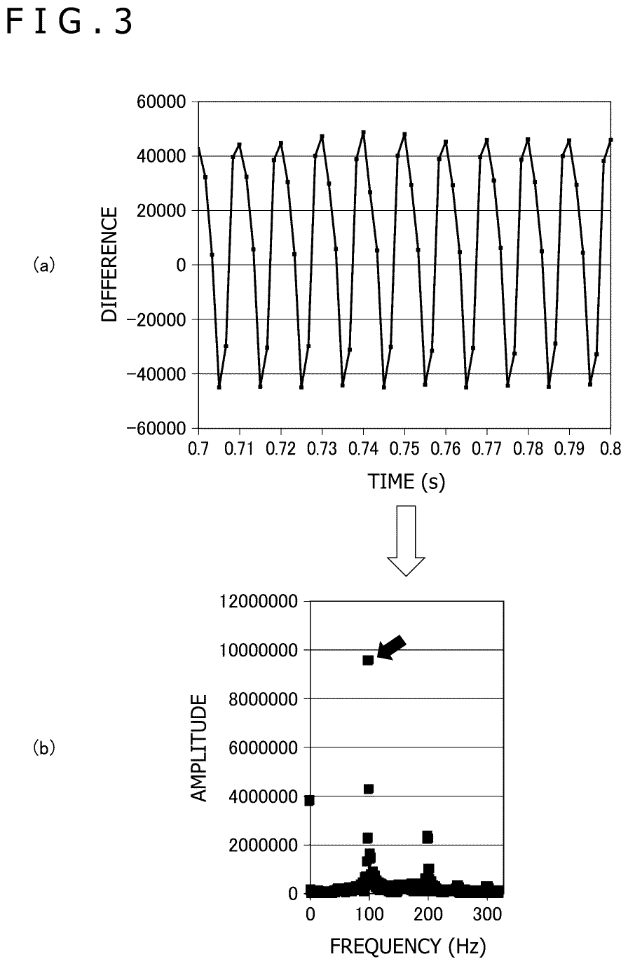

FIG. 3 depicts diagrams for illustrating an example of a process for detecting a time change cycle of the polarity ratio indicated by event signals. In the illustrated example, the cycle detecting section 230 calculates the difference between the number of positive event signals and the number of negative event signals generated for each predetermined period of time as illustrated in FIG. 3(a). Note that FIG. 3(a) illustrates the difference between the number of positive event signals and the number of negative event signals calculated in the example illustrated in FIG. 2, with the horizontal axis as the time and the vertical axis as the difference (in the case where there are more negative event signals, the value becomes negative). The difference calculated in this way indicates the time change in the polarity ratio in the event signals generated for each predetermined period of time. The cycle detecting section 230 can extract the frequency characteristic of the time change in the polarity ratio in the event signals as illustrated in FIG. 3(b) by analyzing the time change in the difference by frequency analysis, specifically FFT (Fast Fourier Transformation). In the illustrated example, a prominent peak frequency is detected at 100 Hz. In this way, the event signals are affected by flicker generated in the surrounding environment as a frequency twice that of the alternating current power supply of the light source (100 Hz in the case where the frequency of the power supply is 50 Hz) and its harmonics.

In the case where the effect of flicker is detected by the frequency analysis in the cycle detecting section 230, specifically, in the case where a peak frequency is detected, for example, the filtering section 240 performs a filtering process on the event signals. As described below, the filtering process may be performed by using the detection result of the peak frequency, or may be performed regardless of the detected peak frequency. On the other hand, in the case where the effect of flicker is not detected by the frequency analysis in the cycle detecting section 230, the filtering section 240 does not perform the filtering process.

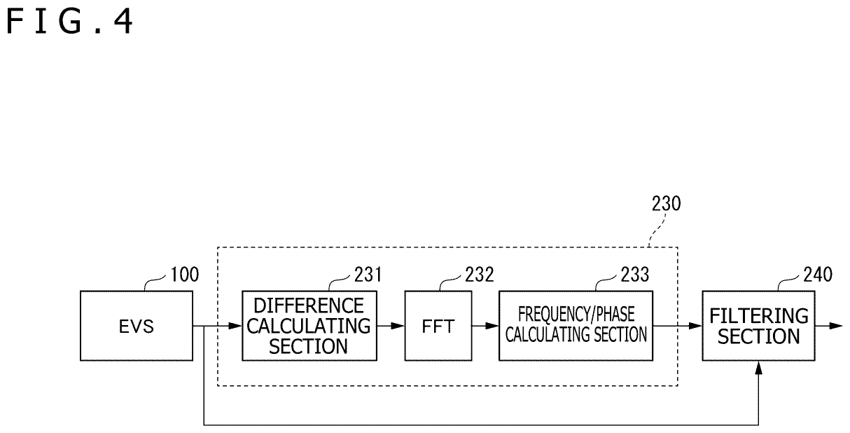

FIG. 4 is a diagram illustrating a first example of a functional configuration for detecting a time change cycle and filtering. In the illustrated example, the cycle detecting section 230 includes a difference calculating section 231, an FFT 232, and a frequency/phase calculating section 233. As in the above example, the difference calculating section 231 calculates the difference between the number of positive event signals and the number of negative event signals generated by the EVS 100 for each predetermined period of time, and the FFT 232 performs frequency analysis on the calculated time change in the difference. In the case where a peak frequency (a frequency component whose amplitude exceeds a threshold value, as described later) is detected by the FFT 232, the frequency/phase calculating section 233 identifies the frequency of the maximum amplitude contained in the peak frequency and the phase of the frequency. The filtering section 240 filters out either positive event signals or negative event signals among the event signals generated by the EVS 100 within a predetermined phase range based on the phase of the frequency of the maximum amplitude.

To be more specific, in the case of calculating the difference by subtracting the number of negative event signals from the number of positive event signals, the filtering section 240 filters out positive event signals in the range of +90° with respect to a phase of 0° of the maximum amplitude frequency component, and filters out negative event signals in the range of 180°±90° with respect to a phase of 0° of the maximum amplitude frequency component. This makes it possible to ignore excessive positive and negative event signals that are alternately and periodically generated due to the effect of flicker as in the example illustrated in FIG. 2 in the processing of the application 250, for example.

Here, the process of filtering out the event signal by the filtering section 240 may be, for example, updating information indicating the presence or absence of an event occurrence and its polarity, which is included in the event signal, from “positive/negative events have occurred” to “no event has occurred.” Alternatively, in the case where the event signal is read out only from the sensor 110 in which an event has occurred, the process of filtering out the event signal executed by the filtering section 240 may be carried out by deleting the event signal itself from the buffer memory 220 or not transmitting the signal to the application 250.

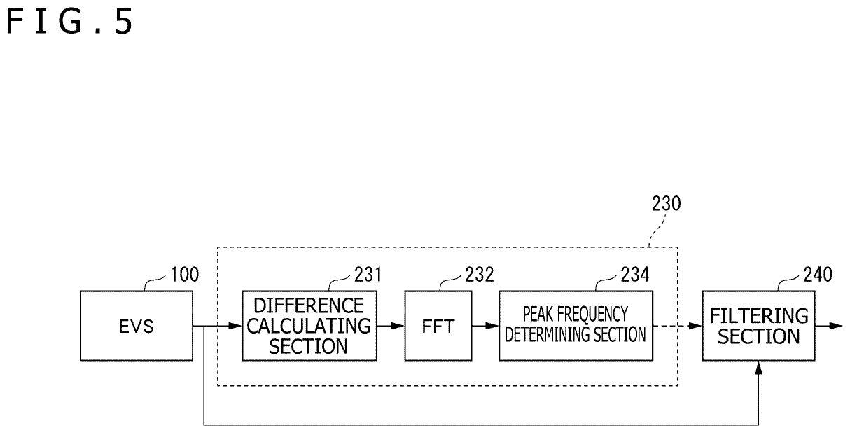

FIG. 5 is a diagram illustrating a second example of the functional configuration for detecting the time change cycle and filtering. In the illustrated example, the cycle detecting section 230 includes the difference calculating section 231, the FFT 232, and a peak frequency determining section 234. As in the first example, the difference calculating section 231 calculates the difference between the number of positive event signals and the number of negative event signals generated by the EVS 100 for each predetermined period of time, and the FFT 232 performs frequency analysis on the calculated time change in the difference. The peak frequency determining section 234 determines that a peak frequency has been detected by the FFT in the case where the frequency components detected by the FFT 232 include a component whose amplitude exceeds a threshold value. Note that, in this example, the frequency and phase of the maximum amplitude included in the peak frequency are not necessarily identified. In the case where a peak frequency is detected, the filtering section 240 filters out positive event signals or negative event signals, whichever is larger in number, generated by the EVS 100 for each predetermined period of time.

In the case of the second example described above, since the filtering process is performed without calculating the phase of the peak frequency, this configuration is not affected by errors in phase calculation due to, for example, granularity errors of the FFT, and can also deal with flicker occurring at frequencies equal to or higher than the Nyquist frequency. On the other hand, in the case where the phase can be calculated accurately, since the first example can remove the effects of flicker with higher precision, it is desirable to select an appropriate method in accordance with the usage environment of the EVS 100 and the calculation performance of the signal processing device 200.

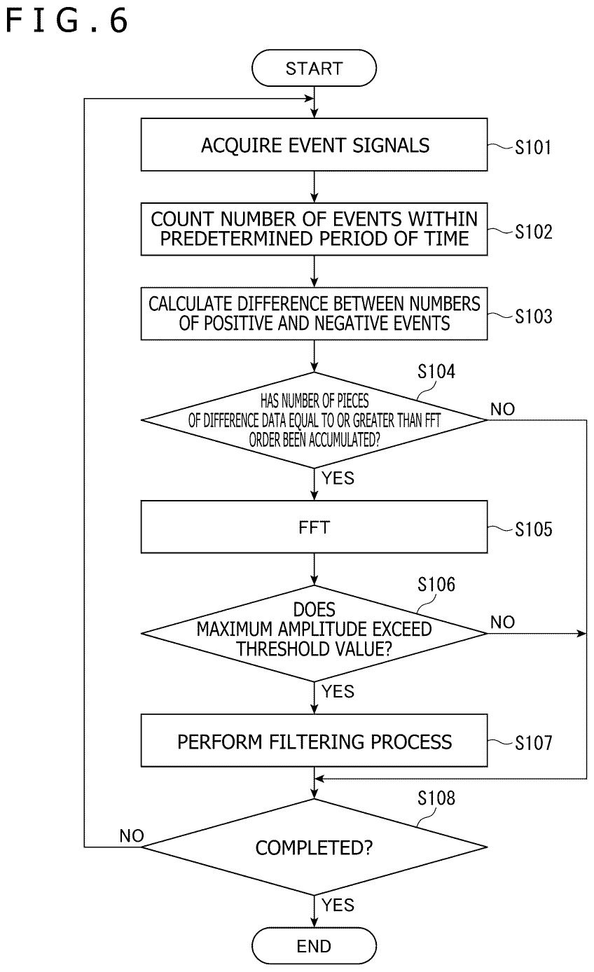

FIG. 6 is a flowchart illustrating an example of the process in the case of the examples of FIG. 4 and FIG. 5. In the illustrated example, when event signals are acquired from the EVS 100 via the communication interface 210 (step S101), the difference calculating section 231 counts the number of positive events and the number of negative events separately within a predetermined period of time (step S102), and calculates the difference between the numbers of positive and negative events (step S103). In the case where the number of pieces of the difference data accumulated for a continuous predetermined time interval becomes equal to or greater than the FFT order (step S104), frequency analysis is performed by the FFT 232 (step S105). In the case where the maximum amplitude of the frequency component detected in the FFT exceeds the threshold value, that is, in the case where a peak frequency is detected (step S106), a filtering process is performed by the filtering section 240 (step S107). The above process is repeated (step S108).

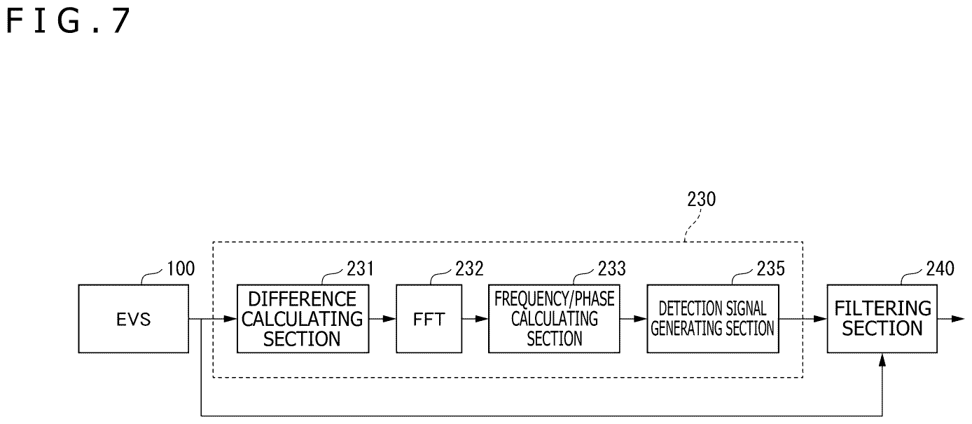

FIG. 7 is a diagram illustrating a third example of the functional configuration for detecting a time change cycle and filtering. In the illustrated example, the cycle detecting section 230 includes the difference calculating section 231, the FFT 232, the frequency/phase calculating section 233, and a detection signal generating section 235. As in the first example, the difference calculating section 231 calculates the difference between the number of positive event signals and the number of negative event signals generated by the EVS 100 for each predetermined period of time, and the FFT 232 performs frequency analysis on the calculated time change in the difference. In addition, in the case where a peak frequency is detected by the FFT 232, the frequency/phase calculating section 233 identifies at least two frequencies included in the peak frequency and the phase of each of the frequencies, and the detection signal generating section 235 generates a detection signal on the basis of the amplitude and phase of each of the frequencies. The filtering section 240 filters out either positive event signals or negative event signals among the event signals generated by the EVS 100 in accordance with the generated detection signal.

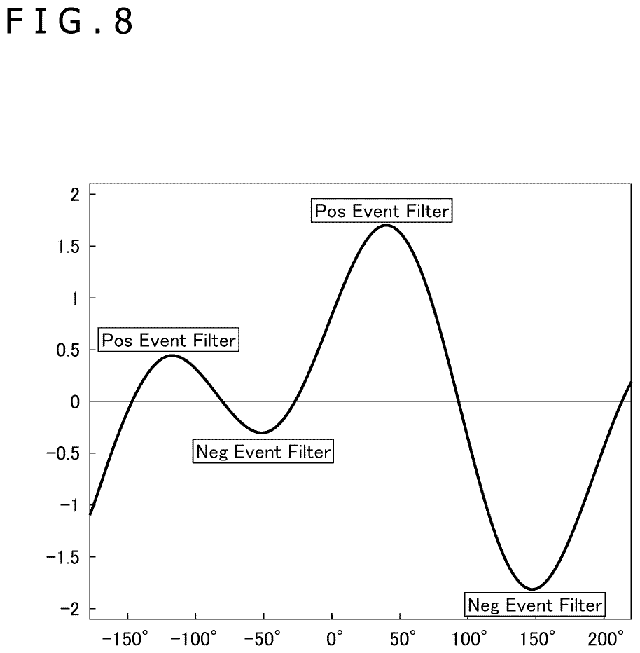

FIG. 8 is a diagram illustrating an example of a detection signal generated in the example of FIG. 7. The detection signal illustrates the composite amplitude of at least two peak frequencies detected by FFT with respect to the phase. In the illustrated example, the filtering section 240 filters out positive event signals in the case where the detection signal has a positive value (Pos Event Filter), and filters out negative event signals in the case where the detection signal has a negative value (Neg Event Filter). Such a detection signal is generated by, for example, combining a detection signal of a peak frequency with a maximum amplitude (for example, cos θ with respect to phase θ) with a detection signal of another peak frequency, specifically, a detection signal of a harmonic of the peak frequency with a maximum amplitude, taking into account the phase difference and the amplitude ratio.

In the case of the third example, the effect of flicker can be removed with higher accuracy by considering harmonics in addition to the maximum amplitude of the peak frequency. Meanwhile, since this is more susceptible to the effect of phase calculation errors, it is desirable to select an appropriate method including the first and second examples in accordance with the usage environment of the EVS 100 and the calculation performance of the signal processing device 200.

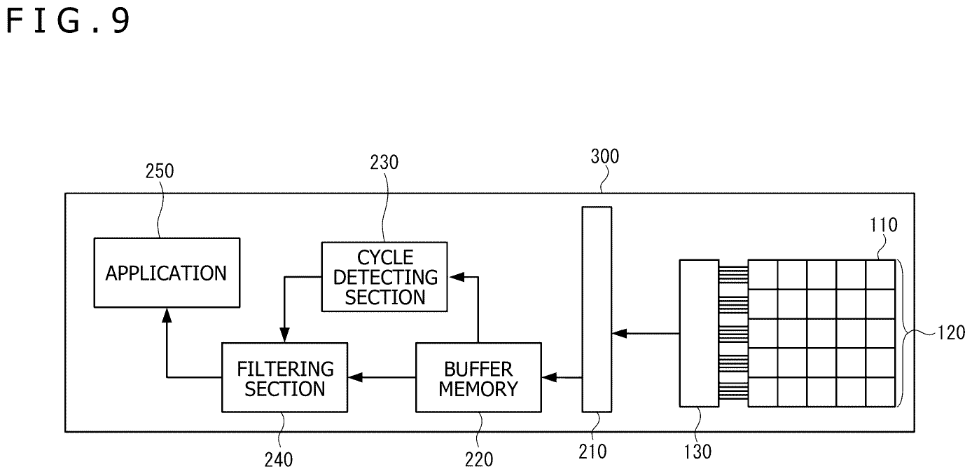

FIG. 9 is a diagram illustrating another example of the configuration of the system according to the embodiment of the present invention. In the illustrated example, the components of the EVS 100 and the signal processing device 200 described above are included in a sensor module 300. In this case, the communication interface 210 is an interface within the device, such as a bus interface. As in the example already described, the function of the application 250 does not have to be included in the sensor module 300, and the event signal processed by the filtering section 240 may be output to an external device or stored in a memory.

### REFERENCE SIGNS LIST

10: System
110: Sensor
120: Sensor array
130: Sensor control unit
200: Signal processing device
210: Communication interface
220: Buffer memory
230: Cycle detecting section
231: Difference calculating section
233: Phase calculating section
234: Peak frequency determining section
235: Detection signal generating section
240: Filtering section
250: Application
300: Sensor module

1. A signal processing circuit that processes event signals that are generated by an event-based vision sensor (EVS) and each indicate a polarity of a luminance change event for each pixel, the signal processing circuit comprising:
a memory for storing a program code; and
a processor for executing operations in accordance with the program code, wherein the operations include:
detecting a time change cycle of a ratio of the polarity indicated by the event signals generated for each predetermined period of time, and
filtering the event signals according to a result of detecting the time change cycle.

2. The signal processing circuit according to claim 1, wherein:
the polarity includes positive and negative polarities;
the detecting the time change cycle includes performing frequency analysis of a time change in a difference between an amount of positive event signals and an amount of negative event signals generated for each predetermined period of time; and
the filtering includes filtering the event signals when a peak frequency is detected in the frequency analysis.

3. The signal processing circuit according to claim 2, wherein the filtering includes filtering out either the positive event signals or the negative event signals in accordance with the peak frequency.

4. The signal processing circuit according to claim 3, wherein the filtering includes filtering out either the positive event signals or the negative event signals within a predetermined phase range based on a phase of a frequency with a maximum amplitude included in the peak frequency.

5. The signal processing circuit according to claim 3, wherein the filtering includes filtering out either the positive event signals or the negative event signals in response to a detection signal generated on a basis of amplitudes and phases of at least two frequencies included in the peak frequency.

6. The signal processing circuit according to claim 1, wherein:
the polarity includes positive and negative polarities, and
the filtering includes filtering out either positive event signals or negative event signals.

7. The signal processing circuit according to claim 6, wherein the filtering includes filtering out the positive event signals or the negative event signals, whichever is larger in number, generated for each predetermined period of time.

8. A signal processing method for processing event signals that are generated by an event-based vision sensor (EVS) and each indicate a polarity of a luminance change event for each pixel, the signal processing method comprising, by an operation executed by a processor in accordance with a program code stored in a memory:
detecting a time change cycle of a ratio of the polarity indicated by the event signals generated for each predetermined period of time; and
filtering the event signals according to a result of detecting the time change cycle.

9. A signal processing circuit including a memory for storing program code for processing event signals that are generated by an event-based vision sensor (EVS) and each indicate a polarity of a luminance change event for each pixel, the program comprising:
by a processor, detecting a time change cycle of a ratio of the polarity indicated by the event signals generated for each predetermined period of time; and
filtering the event signals according to a result of detecting the time change cycle.
